(19) United States
(12) Patent Application Publication
(10) Pub. No.: US 2007/0156502 A1
(43) Pub. Date: Jul. 5, 2007

(54) Tracking and managing contacts through a structured hierarchy

(75) Inventor: Zagros Bigvand, Dallas, TX (US)

Correspondence Address: FULBRIGHT & JAWORSKI L.L.P, 2200 ROSS AVENUE, SUITE 2800, DALLAS, TX, 75201-2784, US

(73) Assignee: Zagros Bigvand, Dallas, TX (US)

(21) Appl. No.: 11/591,991

(22) Filed: Nov. 2, 2006

Related U.S. Application Data
(60) Provisional application No. 60/766,198, filed on Dec. 31, 2005.

(51) Int. Cl. G06Q 99/00; G06F 15/02; G06F 9/46

(52) U.S. Cl. 705/9; 705/1

(57) ABSTRACT

A system and method which manages contacts using a structured hierarchy comprising at least two levels is disclosed. Accordingly, a first contact is introduced or referred to a user by a second contact. In the system a user interface receives information about the first contact and a database stores the received information, wherein the information at least comprises the second contact that introduced the first contact to the user. A structured hierarchy application arranges the contacts within the structured hierarchy, wherein the first contact is adjacent to but not on the same level as the second contact. If the first contact was not introduced to the user by another contact then the first contact is adjacent to the user. The user can access the structured hierarchy to manage his contacts. A vendor network may interface the structured hierarchy for providing items and services to the contacts.

### CROSS-REFERENCE TO RELATED APPLICATIONS

This application claims priority to commonly owned Provisional Application No. 60/766,198 titled “ContactProducer.com” filed by Zagros Bigvand on Dec. 31, 2005. Accordingly, the contents of Provisional Application No. 60/766,198 are herein incorporated by reference for all purposes.

### TECHNICAL FIELD

This invention relates in general to electronic contact storage and, more specifically, to tracking and managing contacts through a structured hierarchy.

### BACKGROUND OF THE INVENTION

In conventional contact storage systems, a user is generally unable to track and organize his referrals and/or contacts efficiently. Conventional systems such as Microsoft Corporation's OUTLOOK™, Sage Software's ACT!®, Leads360 LLC's LEADS360™, LinkedIn Corporation's LINKEDIN®, and Calyx Software's CALYX POINT® enable a user to store information concerning referrals or contacts in a database. For example, when a user receives and/or meets a new contact, that user may enter specific information about that contact in a database. This information may include phone number, address, spouse's name, birthday, anniversary dates, and other contact specific information. The user may recall special events for his contacts, such as birthdays or anniversaries, by accessing the database to review the stored contact information for that contact. The special treatment of referrals and/or contacts is beneficial to the user because these contacts may provide more business for the user in the future. Therefore, the user benefits from contact storage systems by recalling this contact information and interacting with his contacts accordingly.

In conventional systems, the collection of referrals and/or contacts is typically provided to the user as a list and/or a chart. The list or chart may be organized for the user alphabetically, chronologically, or in various other general manners. When the list of contacts becomes voluminous, the user may have difficulties remembering useful information, such as how the contact was provided to him, and what the personal relationships between the contacts are. Accordingly, the user may not be able to determine which contacts are referring him the most business and which contacts have relationships with each other.

### BRIEF SUMMARY

Representative embodiments of the present invention are directed to systems, methods, and computer program products that manage contacts using a structured hierarchy comprising at least two levels. Accordingly, a first contact is introduced or referred to a user by a second contact. In the system a user interface receives information about the first contact and a database stores the received information, wherein the information at least comprises the second contact that introduced the first contact to the user. A structured hierarchy application arranges the contacts within the structured hierarchy, wherein the first contact is adjacent to but not on the same level as the second contact. If the first contact was not introduced to the user by another contact then the first contact is adjacent to the user. The user can access the structured hierarchy to track and manage his contacts.

In some representative embodiments, the structured hierarchy application applies an assessment value to each contact, wherein the assessment value corresponds to a valuation of the contacts that each contact has introduced to the user. This assessment value can also correspond to an amount of financial business provided to the user through each contact. In some representative embodiments, the system also comprises a vendor network that interfaces the structured hierarchy, wherein the vendor network comprises at least one vendor that provides items and services to the contacts at the request of the user. A vendor application may use assessment values to provide items and services to the contacts automatically or at the request of the user.

In other representative embodiments, the information received about a first contact further comprises contact specific information concerning birthdays, anniversaries, personal events, or business events. The system may notify the user of these events, wherein the user can access the vendor network to provide the contacts with items and services corresponding to these events. The vendor application may utilize assessment values, contact specific information, and the vendor network to provide these items and services to the contacts. In addition, the system may group the contacts based upon criteria concerning the information received for the contacts.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the claimed invention, reference is now made to the following descriptions taken in conjunction with the accompanying drawings, in which:

FIG. 1 is a block diagram illustrating a system for tracking and managing contacts, configured according to one embodiment of the present invention;

FIG. 2 is a flow chart illustrating example steps executed to implement one embodiment of the present invention;

FIG. 3 is a block diagram illustrating an example of a tree hierarchy produced by a system configured according to one embodiment of the present invention;

FIG. 4 is a screen shot illustrating a homepage for a website in one embodiment of the disclosed invention;

FIG. 5 is a screen shot illustrating a contact information webpage for a website in one embodiment of the disclosed invention;

FIG. 6 is a screen shot illustrating an events webpage for a website in one embodiment of the disclosed invention;

FIG. 7 is a screen shot illustrating a find and view contacts webpage for a website in one embodiment of the disclosed invention;

FIG. 8 is a screen shot illustrating a manage lists webpage for a website in one embodiment of the disclosed invention;

FIG. 9 is a screen shot illustrating a homepage of a specific user of a website in one embodiment of the disclosed invention;

FIG. 10 is a screen shot illustrating a search wizard webpage for a website in one embodiment of the disclosed invention; and

FIG. 11 is a block diagram of a processor-based computer system, configured according to one embodiment of the present invention.

### DETAILED DESCRIPTION OF THE INVENTION

The present disclosure describes managing contacts using a structured hierarchy. The hierarchy comprises the contacts or referrals for a user, wherein the contacts or referrals may be arranged into levels within the hierarchy. The hierarchy of levels represents the personal or business relationships between the contacts. When a new contact is introduced or referred to a user, the new contact may be placed adjacent to (i.e., below) the contact that introduced or referred the new contact to the user. If the new contact was not introduced or referred by another contact within the hierarchy, then the new contact may be placed adjacent to (i.e., below) the user, or in alternative embodiments the new contact may be on the same level as the user. Accordingly, a new contact may be described as a descendent of the contact that introduced the new contact to the user. As the contacts of the user grow, the structured hierarchy enables a user to visually track and manage these contacts by assigning each contact to a specific position and level within the hierarchy. Assessment values may be applied to each contact within the structured hierarchy, wherein the assessment value represents a valuation of the contacts that each contact has provided to the user. This assessment value may correspond to the number of contacts provided by each contact, the number of transactions applied to each contact, the financial business attributed to each contact, or other similar information of value to the user.

In one embodiment, this system and method may be provided through an Internet website that can be accessed through an Internet connection. The website may also be accessed through an Intranet network or other computer access network. This system may also be provided through a computer network, such as an internal computer network of a corporation. In certain embodiments, the system may be installed on each computer within the network, wherein access to a website is not required. In other embodiments, this system may be added to and/or integrated with existing computer programs or computer services, such as email programs or contact databases. In addition, computer programs embodying this system may be installed on mobile telephones, computer terminals, personal digital assistants (“PDAs”), and other data processing devices, wherein the user can utilize the features of this system through these devices. This system may be installed on a single computer terminal for the use of one or multiple users. The claimed invention is not limited to these disclosed configurations. Many additional configurations are within the scope of this disclosure. Throughout this disclosure many of the functions of the claimed invention may be controlled and provided by computer hardware, computer software, or a combination of hardware and software. Computer software may refer to computer programs comprising specifically designed algorithms that carry out the functions disclosed. Computer programs may comprise computer code disposed on a computer-readable medium.

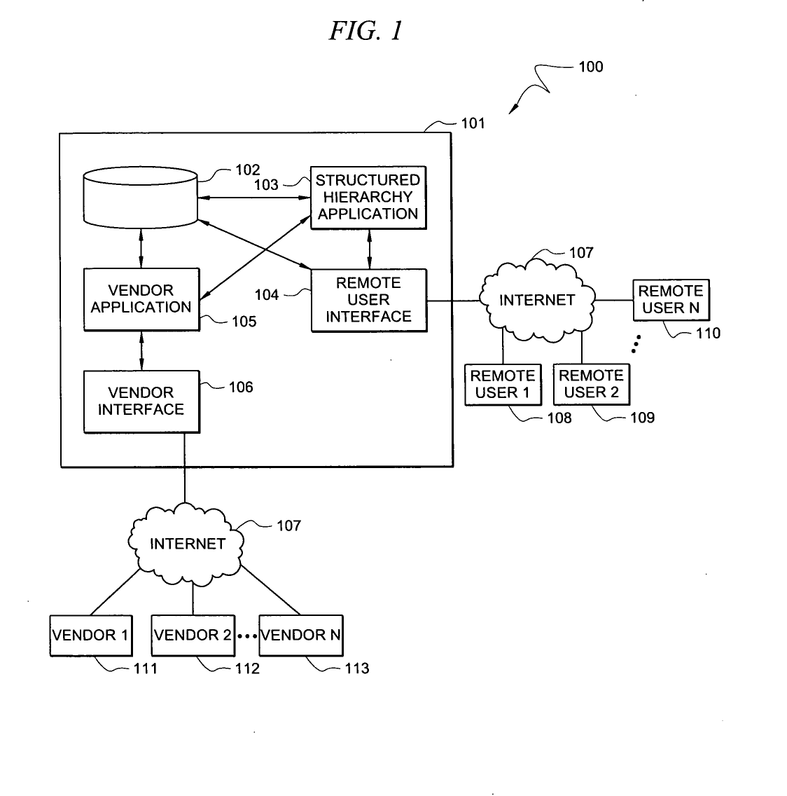

FIG. 1 is a block diagram illustrating a system 100 for tracking and managing contacts, configured according to one embodiment of the present invention. Computer system 101 comprises contact information database 102, structured hierarchy application 103, vendor interface 106, vendor application 105, and remote user interface 104. Contact information database 102 is a database for storing contact specific information and user specific information. A computer program may be designed for receiving the information from the user, transmitting the information to the database, and storing the information within contact information database 102. Structured hierarchy application 103 creates the contact hierarchy using the contact specific information from contact information database 102, and more specifically, the information pertaining to the relationships between the user and the contacts. Structured hierarchy application 103 also calculates the assessment values applied to each contact. A computer program may be designed for creating the structured hierarchy and calculating the corresponding assessment values of each contact. The creation of the structured hierarchy and the determination of the assessment values applied to each contact will be discussed in further detail herein.

Computer system 101 comprises a remote user interface 104 that connects to remote users 108, 109, 110 through Internet 107. Accordingly, remote user1 108 can access computer system 101 through Internet 107, wherein remote user1 108 can enter contact specific information and user specific information. Remote user1 108 may enter this information through a computer terminal, a laptop, a PDA, or other similar device (not shown) connected to Internet 107. Computer system 101 includes vendor interface 106 that connects to vendors 111, 112, 113 through Internet 107. Vendors 111, 112, 113 may comprise a vendor network that supplies various items and services to the contacts and the users of the system. Accordingly, vendor1 111 may exchange information directly with computer system 101 and indirectly with the remote users 108, 109, 110 through Internet 107. In one embodiment, vendor specific information may also be stored in contact information database 102. Vendor specific information may include information on such items as products, pricing, and delivery options. The interaction between computer system 101 and vendors 111, 112, 113 will be discussed in further detail herein. Vendor access to computer system 101 may be controlled to varying degrees by vendor application 105. Vendor application 105 is used to control the vendor network interaction with structured hierarchy application 103, which enables remote users 111, 112, 113 to provide items and services to their contacts through the vendor network. Accordingly, vendor application 105 may restrict access to the contact specific information and the user specific information stored in contact information database 102.

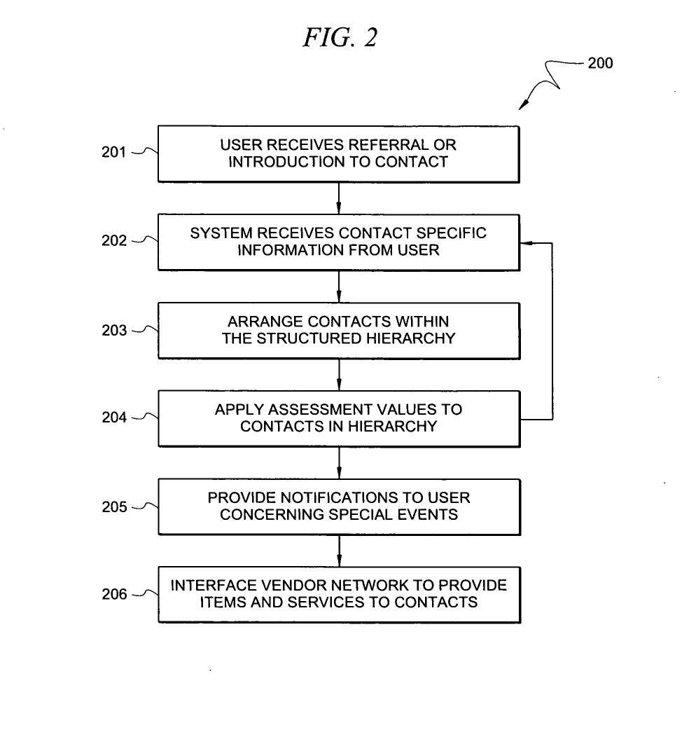

FIG. 2 is a flow chart illustrating example steps 200 executed to implement one embodiment of the present invention. First, a user receives a referral or an introduction to a contact in step 201. The new contact was referred or introduced by another contact within the structured hierarchy of the user. Within this disclosure, an “introduction” to a contact may comprise an actual meeting between the user and the new contact or the referral of the new contact's business to the user. This “introduction” may also include financial business provided to the user by the new contact or any leads provided to the user by the new contact. Accordingly, the “introduction” of a new contact should not be limited to specific types of referrals or new relationships.

Subsequently, the system receives contact specific information from the user in step 202 through the Internet. As previously described, this information may comprise the contact that introduced the new contact, phone number, address, spouse's name, kids' names, birthdays, specific anniversary dates, critical business dates, and other pertinent or desirable information. The system then uses the information provided to place the new contact into the structured hierarchy, and arrange the remaining contacts accordingly in step 203. The contacts are arranged within the hierarchy according to their relationships with the other contacts and/or the user. After the structured hierarchy is arranged properly, the system may apply updated assessment values to the contacts in the structured hierarchy in step 204. The determination of the assessment values for each contact are described herein. After these steps, the user may enter the system and provide information concerning another contact by repeating step 202.

After creating the structured hierarchy, the system may also provide notifications to the user in step 205, concerning special events of the contacts within the structured hierarchy. For example, the system may notify the user of birthdays, anniversaries, personal events and/or critical business events of the contacts within the structured hierarchy. After receiving these notifications, the user may use the system to interface a vendor network in step 206 and provide items and/or services to selected contacts. Within this disclosure, the “items and services” provided by vendors is not limiting and refers to the gamut of products and/or services that may be provided by vendors. Accordingly, a vendor may provide an item or a service in one transaction, and an item and a service in another transaction.

For example, after receiving a birthday notification the user may decide to send a birthday card or a birthday present through the vendor network. Selecting a birthday card or a birthday present may involve the purchasing of the actual card or present and the shipping of the card or present. In other embodiments, purchasing a birthday present may involve buying a product (item) or a service, but not both. In another embodiment, the system may notify the user of an upcoming holiday such as Christmas. After receiving this notification, the user may use the system to interface the vendor network and provide Christmas cards or Christmas presents to multiple contacts.

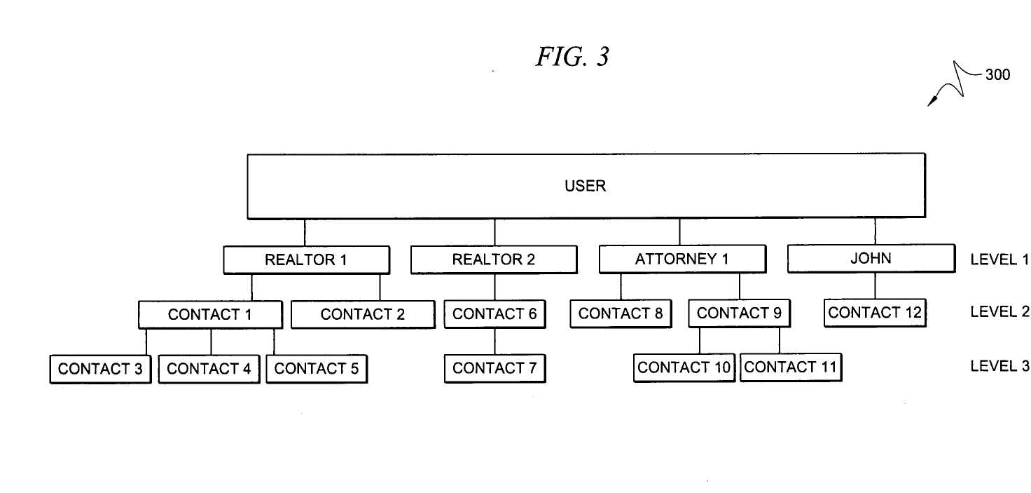

FIG. 3 is a block diagram illustrating an example of tree hierarchy 300 produced by a system configured according to one embodiment of the present invention. As shown in tree hierarchy 300, each individual (contacts and user) may be represented by an object (rectangular box) containing a name that corresponds to the individual or contact. Many other types of objects may be used to represent the contacts within the hierarchy. The user is located at the top of tree hierarchy 300. Tree hierarchy 300 is shown in FIG. 3 as the structured hierarchy, but many different configurations are within the scope of this disclosure. For example, the structured hierarchy could be shown in a wheel and spoke configuration or another type of structured configuration. In a wheel and spoke configuration, the user may be the center of the hierarchy. Tree hierarchy 300 may be displayed for the user on a computer screen or equivalent thereof. From the display screen, the user may recall contact specific information by selecting a contact from the screen. In alternative embodiments, a user may be able to create a hierarchy representing family relationships, such as a family tree.

Realtor1, Realtor2, Attorney1, and John are illustrated as contacts or referrals that have a direct relationship with the user. These contacts may have brought financial business to the user, may be friends or acquaintances of the user, or may be business associates of the user. The structured hierarchy can be set up in many different manners, and there are many different relationships that can be tracked through hierarchy 300. Leads may also be tracked in this structured hierarchy 300. In this example, the user is a loan officer and Realtor1 and Realtor2 have provided multiple clients to the user. Attorney1 is a friend of the user who has also provided multiple clients to the user. John is a direct client of the user who has referred an additional client to the user, Contact12. These contacts (Realtor1, Realtor2, Attorney1, and John) may comprise a first level, Level 1, of contacts within hierarchy 300.

Hierarchy 300 does not represent the relationships of the contacts within a same organization, business, or connected line of work, although multiple contacts may work in a same organization, business, or connected line of work. As shown in FIG. 3, the contacts are in different lines of work. Hierarchy 300 does not represent a group of contacts working towards a common goal of selling products or services within an organization, such as a multi-level marketing organization. These contacts are arranged within hierarchy 300 according to their relationships to the user and not because of their connections within an organization, business, or connected line of work.

Realtor1 has directly provided two contacts, Contact1 and Contact2, to the user. Contact1 and Contact2 are placed on the second level, Level 2, of contacts within hierarchy 300. Contact1 has also directly provided three contacts, Contact3, Contact4, and Contact5, to the user. These contacts, Contact3, Contact4, and Contact5, are placed on the third level, Level 3, of contacts within hierarchy 300. Accordingly, Realtor1 is responsible for referring two direct contacts and five contacts all together. Realtor1 may be considered a valuable contact because his relationships have resulted in five new contacts for the user. Contact1 may also be considered a valuable contact due to his referral of three new contacts to the user. Because of the layout of hierarchy 300, the user can easily see which of his contacts have been most valuable to him.

Contact1, Contact2, Contact3, Contact4, and Contact5 are considered to be in the downline of Realtor1. Contact3, Contact4, and Contact5 are considered to be in the downline of Contact1. Accordingly, the downline of a contact may be described as the contacts that have been referred or introduced to the user through that contact's relationships. Contact1 and Realtor1 are considered to be in an upline of Contact5.

Realtor2 directly provided one contact, Contact6, to the user. Contact 6 directly provided one contact, Contact7, to the user. Accordingly, Contact6 is placed on the second level, and Contact7 is placed on the third level of the contacts within hierarchy 300. Attorney1 directly provided two contacts, Contact8 and Contact9, to the user. Contact9 directly provided two contacts, Contact10 and Contact11, to the user. Accordingly, Attorney1 is responsible for referring two direct contacts and four contacts in all. John directly provided one contact, Contact12, to the user.

It should be noted that additional and/or alternative embodiments of the present invention may provide assessment values corresponding to each contact, wherein the assessment value represents the contacts or financial business that each contact has provided to the user. In one embodiment, the values could be determined by giving a value of “1” for each contact generated and adding the number of contacts within a downline of a particular contact. Therefore, Realtor1 would have an assessment value of “5,” Contact1 would have a value of “3,” Attorney1 would have a value of “4,” John would have a value of “1,” and Contact12 would have a value of “0.” These values applied to the contacts would enable the user to assess the value of each contact, and then treat his relationship with each contact accordingly. In another embodiment, direct relationships may be valued greater than indirect relationships when determining the assessment values.

In additional and alternative embodiments, the assessment values could be determined by placing a value of “1” for each transaction that is generated by a contact for the user and adding the number of transactions within a downline of a particular contact. As an example, Realtor1, Contact1, Contact4 and Contact5 each engaged in one transaction with the user. Contact2 engaged in two transactions with the user, and Contact3 engaged in three transactions with the user. The assessment value can be determined by adding the number of transactions within the downline of a contact. Accordingly, Realtor1 may have an assessment value of “8,” Contact1 may have an assessment value of “6,” Contact3 may have an assessment value of “3,” and Contact2 may have an assessment value of “2.” In one embodiment, transactions from direct contacts may be assessed a higher value than transactions from indirect contacts. Moreover, different types of transactions may be assessed different values or values may have a shelf life. For example, after the passage of a certain amount of time without activity, the point for a transaction may go away. In one embodiment, if a new transaction is closed the shelf life and the corresponding points are renewed for the contact that may have lost points due to inactivity. Accordingly, the passage of time may affect the assessment values.

In an alternative embodiment, the system may use the financial business generated for the user by each contact to determine the assessment values. The financial business may refer to the monies generated from each contact relationship. If the user is a loan officer, then the financial business generated may refer to the amount of commissions received due to the transactions from each contact. The assessment value may be determined by adding the financial business within the downline of a contact. For example, Realtor2 provided $10,000 in commissions for the user, and Contact6 and Contact7 provided $15,000 in commissions for the user. Therefore, Realtor2 has an assessment value of $40,000, Contact6 has an assessment value of $30,000, and Contact7 has an assessment value of $15,000. As another example, John did not engage in a transaction with the user, but Contact12 engaged in a $10,000 transaction with the user. In this situation John and Contact12 both have assessment values of $10,000. As previously described, the financial business derived from a direct contact may be valued higher than financial business derived from an indirect contact. These embodiments for assessing values for the contacts are only provided as examples and do not limit the scope of this disclosure. Accordingly, many other embodiments for calculating assessment values for the contacts are within the scope of this disclosure. Specifically designed computer programs may be utilized to provide the assessment values.

The structured hierarchy and the assessment values applied to the contacts may enable the user to efficiently track and manage his referrals and/or contacts. The user can determine the relationships between his contacts by viewing the structured hierarchy. Accordingly, the user may be able to quickly determine that Contact5 has a direct relationship with Contact1, and Contact1 has a direct relationship with Realtor1. The user may determine that Realtor1 and Attorney1 have produced the most contacts by viewing the structured hierarchy. In addition, by reviewing the assessment values of the contacts the user may determine that Realtor1 and Attorney1 are his most valued contacts. These features may enable the user to efficiently determine the value of a specific contact or referral due to the contacts or financial business provided by the specific contact.

The assessment values may also be used in determining what types of items and/or services the user provides to his contacts. For example, the user may wish to send a birthday message through email to contacts with a lower assessment value and send personal birthday cards to contacts with a higher assessment value. For Christmas the user may wish to send a modest gift to contacts with a lower assessment value and send an elaborate gift to contacts with a higher assessment value. These features enable the user to manage the treatment of his contacts more efficiently.

As previously described, the system may further include connection to a vendor network. There is a wide variety of items and services that a user may wish to provide for his contacts or referrals. The user may wish to provide greeting cards, flowers, gifts, and special event tickets, or host a dinner or a party for his contacts. These items and services may be provided by outside vendors, such as flower shops, restaurants, ticket brokers, and event planners. In some embodiments, the user can access these vendors through this system. Accordingly, the system and the vendors may come to an agreement concerning their financial relationship, wherein the vendors can supply the users of the system with the items and services requested. For example, the owner of the system may receive commissions for the products bought from the vendor network by the users. The vendors may also be able to access contact information and user information to make this interaction more efficient.

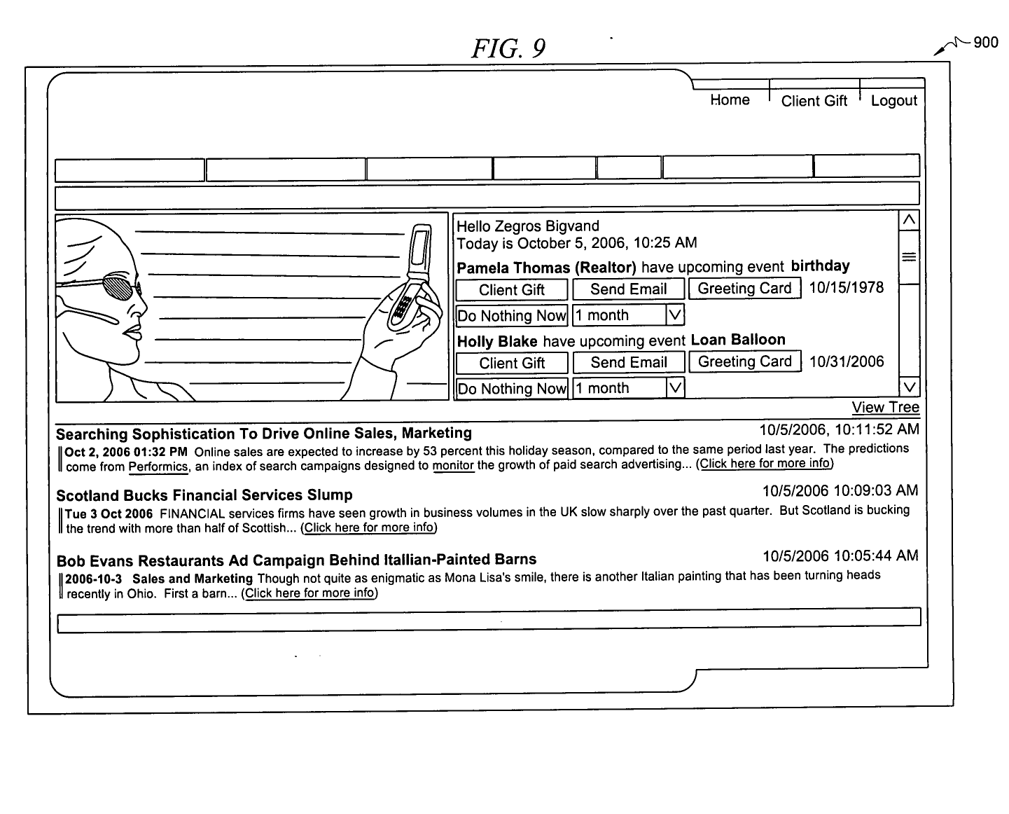

For example, the system may notify the user that a specific contact, Realtor1, has a birthday next week. Notifications provided to the user by the system are shown with reference to FIG. 9. The notification may also provide the assessment value for Realtor1, which alerts the user that this is a valuable contact. Through the system the vendor network may provide the user with different items and services that can be purchased for Realtor1. This feature enables the user to quickly and efficiently provide a birthday card or present for Realtor1.

In some embodiments, the user may select specific treatment for specific contacts, wherein the items and services may be provided automatically by the system. For example, a user may determine that contacts with an assessment value less than “3” receive a birthday card, contacts with an assessment value less than “6” and greater than or equal to “3” receive a small birthday gift, and contacts with an assessment value of “6” or greater receive a special birthday gift. The user may enter these specifications into the system. Also, the user information (name, address, credit card number, etc.) and the contact information (name, address, spouse and kid's names, birthday, etc.) may be accessed by the vendors or transmitted to the vendors, so that the user may have to enter little or no information. Accordingly, the system may be able to provide appropriate cards and gifts to the contacts for the user automatically.

In other embodiments, the system may independently produce the items and/or services that may be provided by the vendors. For example, a computer program may be utilized by the system to create greeting cards or email messages for special events relating to the contacts. The email messages and greeting cards may be selected by the user, wherein the contact specific information is provided by the system and the emails and/or cards are sent to the contacts accordingly. In alternative embodiments, these greeting cards or email messages may be produced automatically without a request from the user for each event. The user may also select email messages to be sent to all contacts on recurring events, such as a loan anniversaries, without any subsequent user input. These features may also be provided for other items and services.

The system may also send out email messages to inquire about information concerning the contacts of a user. For example, a user may import a contact from Microsoft OUTLOOK™ to be added to his structured hierarchy. When this new contact is positioned in the hierarchy, the system may send an email to the contact to capture additional contact information, such as favorite restaurants, types of music, foods, sports, hobbies, birthdays, family information, and anniversaries. The system may also request the contact to become a user. In this manner the contact specific information can be easily transferred to the structured hierarchy of the user. This feature can also be used after adding a new contact, wherein the system sends out an email to the contact at the request of the user when a new contact is added to the structured hierarchy. Plaxo Incorporated's PLAXO® service provides similar contact services, but does not apply to a structured hierarchy as described herein.

In some embodiments, a user may have multiple structured hierarchies to represent different business ventures or different groups of contacts. For example, if the user is a loan officer and a house builder then he may want to track and manage his contacts independently.

The system may be implemented to manage contacts that are not positioned within the structured hierarchy. For example, if the user wished to store contact specific information for family members, but does not want them to be in the structured hierarchy, then these contacts may be stored in an address book. The features of this system, such as the notification feature, can be implemented for contacts that are not positioned within the structured hierarchy. For example, the user may receive birthday notifications for family members that are not positioned in the structured hierarchy.

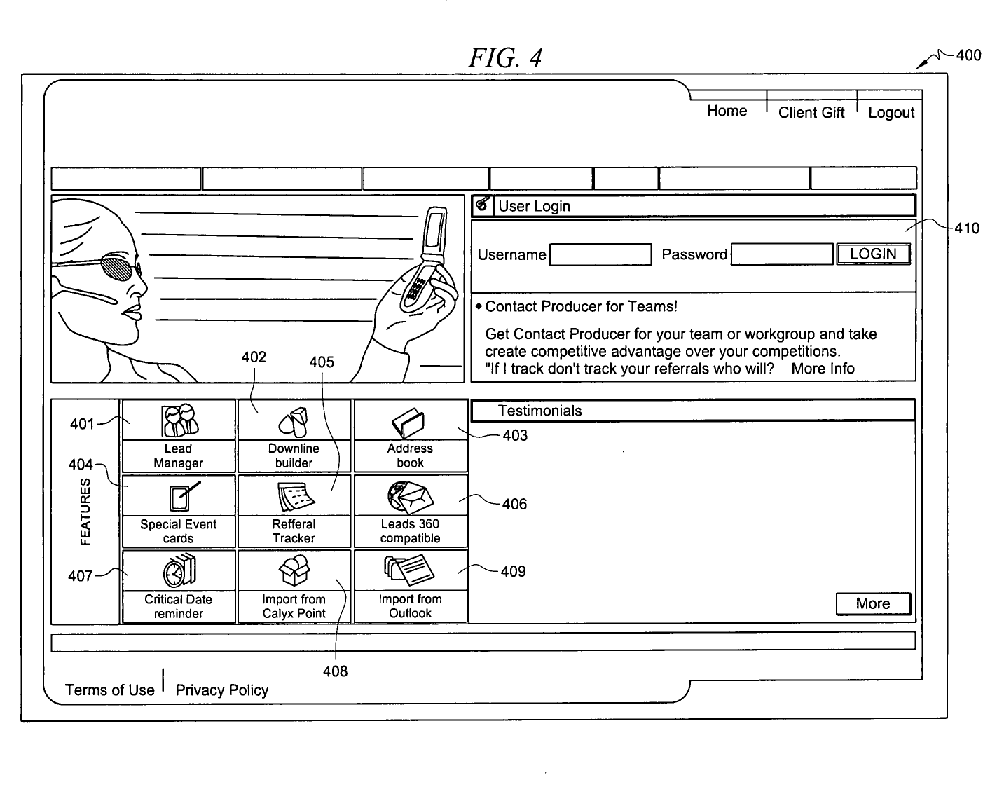

FIG. 4 is a screen shot illustrating homepage 400 for a website in one embodiment of the disclosed invention. This embodiment of the disclosed invention involves remote users than can access the system through an Internet or an Intranet network connection. As shown, User Login box 410 enables a remote user to log into the system. The user provides a Username and a Password that enables the user to enter the system.

Lead manager 401 is offered for assisting the users with managing and tracking their leads. Accordingly, leads for potential business are arranged into a structured hierarchy. In one embodiment, contacts may be able to access the system to provide leads for the user, wherein the leads are stored within the contact specific information. A contact may also be able to view his downline of contacts or leads within the user's structured hierarchy. Also, the user may allow a contact to view his upline of contacts, which refers to the relationships that led to the introduction of the contact to the user. This feature may require the contact to receive access information from the user or the system. The user may control the amount of contact information that his contacts may access.

Other features on homepage 400 include an import feature. The system may allow a user to import his contacts, referrals, and/or leads from a different program or service. For example, a user imports his contacts from Microsoft OUTLOOK™ 409, LEADS360® 406 or Calyx POINT® 408. In one embodiment, the user selects a file to be imported and a computer program may be used to access the foreign program or service, gather the necessary contact information, and transmit this information to the system for storage in the structured hierarchy. In addition, the system may be implemented to export databases or client information from this system to foreign programs or services.

The user accesses the structured hierarchy to update the hierarchy through downline builder feature 402. Address book feature 403 provides a list or chart of contacts and their contact specific information. Special event cards feature 404 enables the user to produce cards or email messages for special events of the contacts, such as a birthday or a positive business event. In an alternative embodiment, special event cards feature 404 enables the user to produce cards or email messages for special events of the user, such as a Christmas party, a conference, or a client party. Referral tracker feature 405 produces a list of referrals that has been provided to the user through his contact network. In an alternative embodiment, feature 405 tracks the amount of financial business provided through these referrals. Critical date reminder feature 407 produces notifications for the user of critical dates concerning his contacts. Feature 407 provides notifications for special events of the contact and/or critical business dates, such as payment dates, renewal dates or closing dates.

In some representative embodiments, another feature may include utilizing the structured hierarchy of contacts to focus advertising and marketing efforts. Specific computer programs use the structured hierarchy to ensure that advertising campaigns or marketing campaigns are reaching potential clients. The system may review the contact specific information of the most valuable contacts and assist the user in determining how to reach them with marketing and/or advertising. For example, this feature may determine that realtors have provided the user with the most valuable contacts, and therefore the user should try to reach realtors with his efforts. Also, if most of the valuable contacts like to play golf, then a sponsored golf event may be an efficient method of reaching potential clients. This feature may be implemented in many different manners, and this brief description of this feature is only provided as one example.

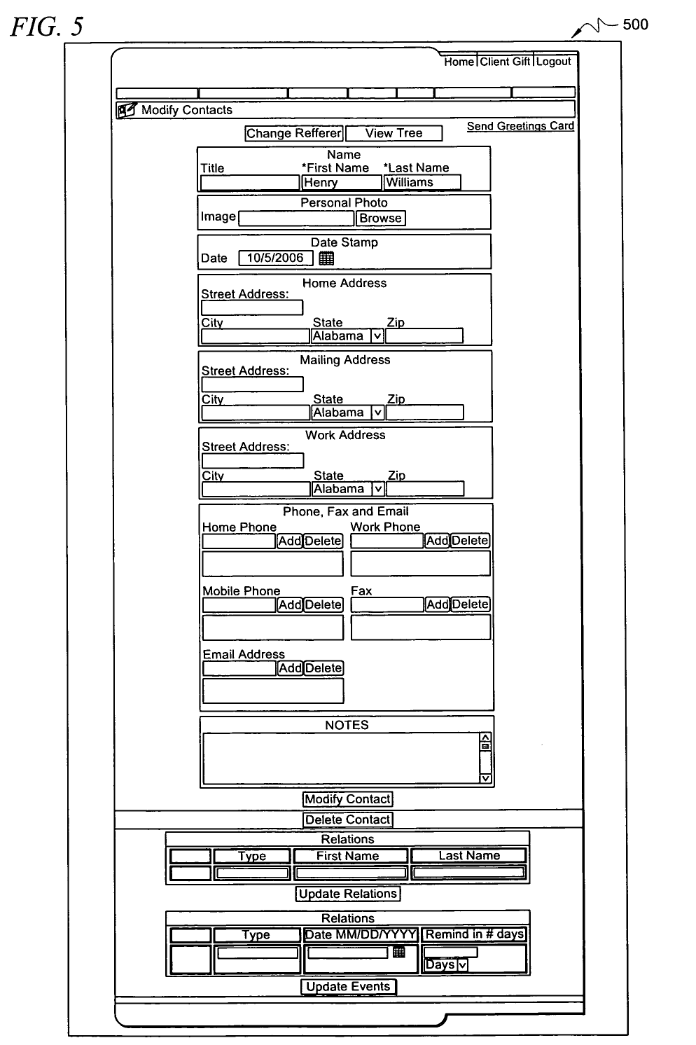

FIG. 5 is a screen shot illustrating contact information webpage 500 for a website in one embodiment of the disclosed invention. Accordingly, the contact specific information comprises name, personal photo, home address, mailing address, work address, phone number, fax number, and email address. A notes section allows the user to enter additional contact information that may include spouse's name, activities or interests, and/or other information that may be beneficial to the user's relationship with the contact. This webpage 500 includes a date stamp for tracking the date at which the user was introduced or referred to the user. The user can delete contacts from the database if desired. In some instances a user may wish to delete a contact if there has been no communication in a long period of time or the contact has not provided any referrals in a long period of time.

A relations section allows a user to enter relationship information concerning a contact. Accordingly, the user enters the contact that referred the new contact to the user, which the system utilizes for building the structured hierarchy. An events section enables the system to notify the user of important or critical events. The user inputs special events for the contact and/or critical business events for the contact.

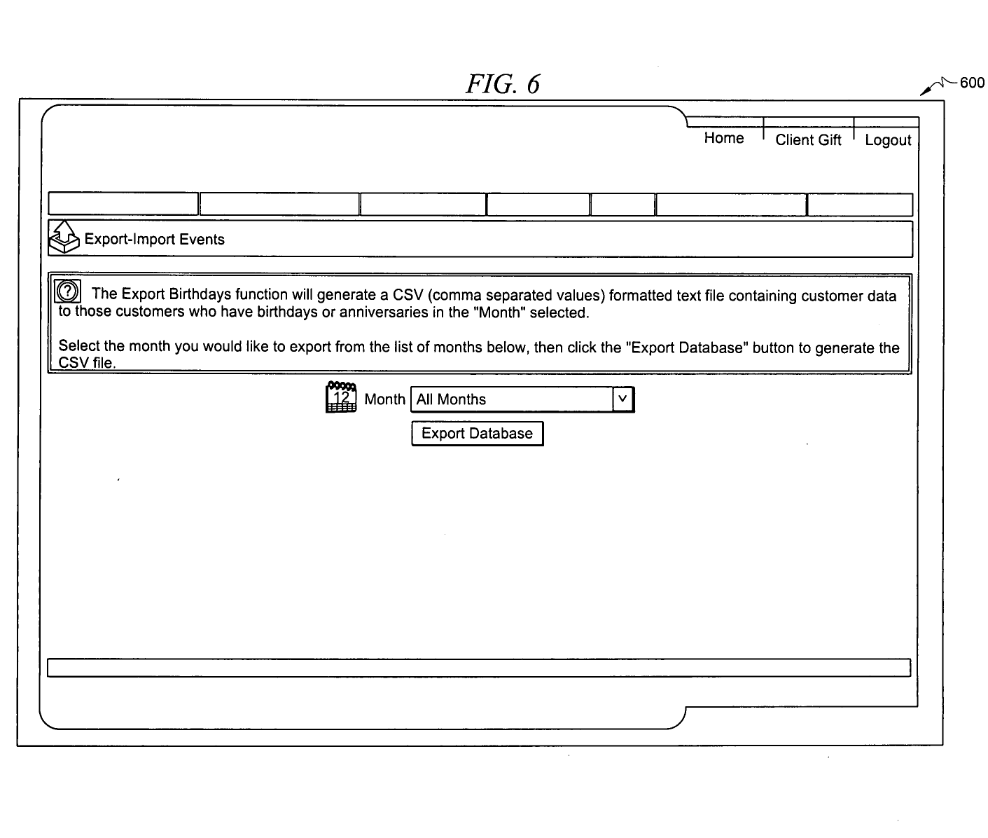

FIG. 6 is a screen shot illustrating events webpage 600 for a website in one embodiment of the disclosed invention. Events webpage 600 enables the user to prepare lists or files of specific events in a selected month through the system. For example, an export birthdays function creates a formatted list or a calendar with all of the contacts having a birthday within the selected month. In some embodiments, this function produces a calendar of the month of October with all of the October birthdays imprinted thereon. Another function enables a user to produce a list or chart of critical business events for a selected week, month or quarter. As shown in events webpage 600, this information can be exported to a foreign program or service. For example, the user may export a list of birthdays into a calendar from another program or service, such as Microsoft OUTLOOK™, wherein the birthdays are entered into the calendar.

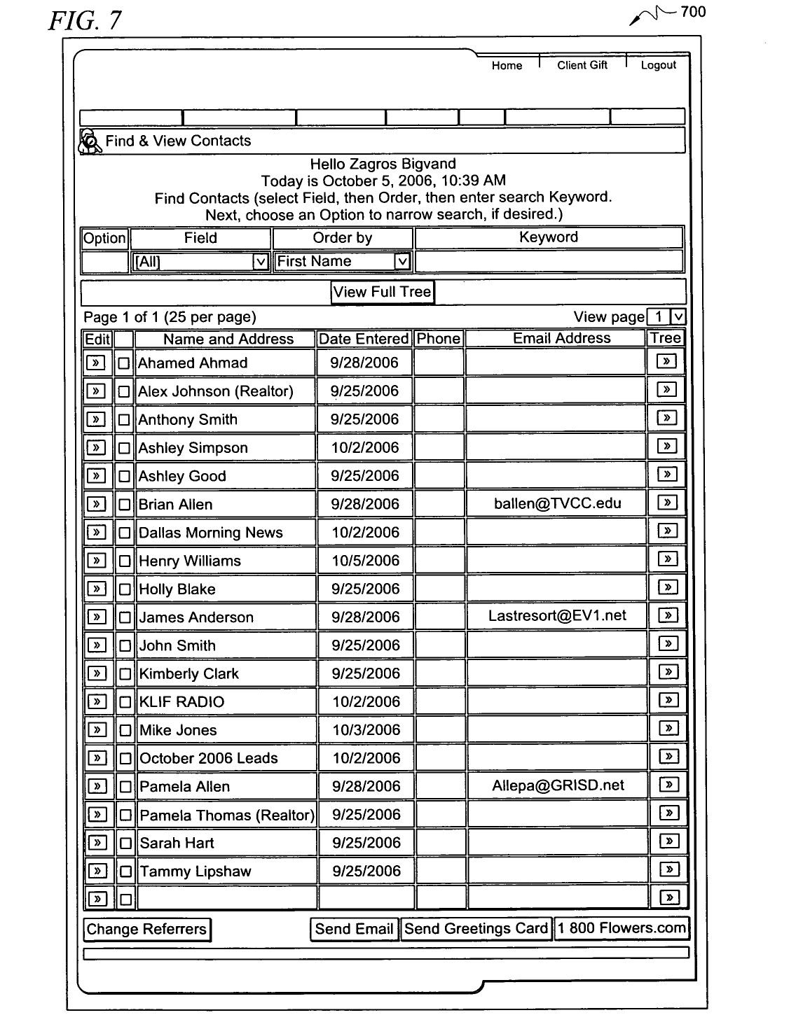

FIG. 7 is a screen shot illustrating find and view contacts webpage 700 for a website in one embodiment of the disclosed invention. Find and view contacts webpage 700 enables the user to prepare lists or charts of the contacts represented in the structured hierarchy. The lists are prepared according to many different criterion. For example, the list could be prepared in alphabetical order or chronological order, which would enable the user to view a timeline of his contacts. Also, a list could be prepared that groups the contacts that have engaged in one specific type of transaction, or that have produced a specific amount of financial business. Geographical location or type of interests could be additional manners of grouping the contacts. This feature enables the user to plan events for groups of contacts with common interests or contacts that live near each other. For example, a golf outing could be planned for contacts that enjoy golf and are acquaintances within in the same group of contacts. Within the scope of this disclosure many different manners of grouping the contacts can be utilized by the user. This feature may be controlled by a grouping application, wherein a computer program searches through the contacts for selected criteria and then organizes the contacts with this criteria into a group or list.

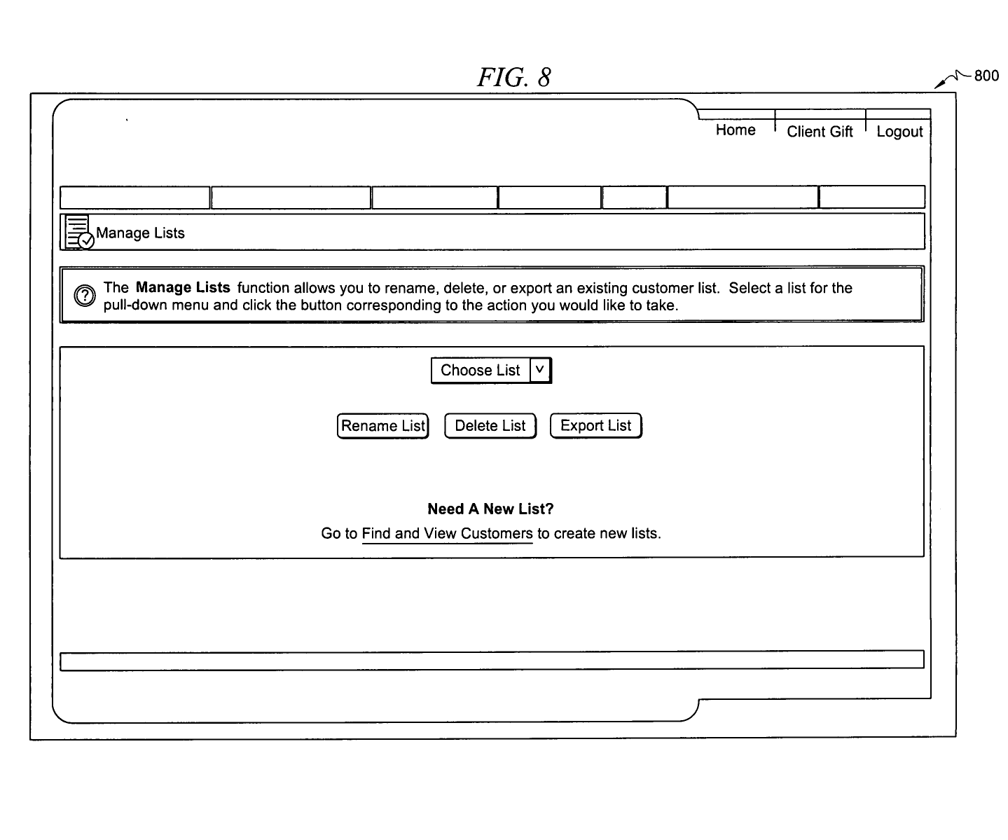

FIG. 8 is a screen shot illustrating manage lists webpage 800 for a website in one embodiment of the disclosed invention. Manage lists webpage 800 enables the user to rename lists, delete lists or export lists. As described with reference to FIG. 7, the user can create lists that group the contacts based upon contact specific information. These lists are stored by the system for quick access by the user. The manage list webpage 800 enables the user to manage these lists.

FIG. 9 is a screen shot illustrating homepage 900 of a specific user of a website in one embodiment of the disclosed invention. Homepage 900 is the homepage for a user, Zagros Bigvand. As shown in FIG. 9, notifications of special events and critical business events are shown on homepage 900. The user also has selected news articles or summaries shown on homepage 900. These news articles or summaries may relate to the user's business and/or interests. In one embodiment, the user may be able to send news articles or summaries to selected contacts through the system. The website may also sell advertising on user homepages. This advertising could be focused towards the business and personal activities of the user.

After viewing the notifications, the user may wish to send a gift to the contact, send an email to the contact, or send a greeting card to the contact. The user can select the “client gift” option, wherein the user may be routed to the vendor network. From the vendor network the user selects an appropriate gift. The user may wish to review the contact specific information and/or the assessment value of the contact before selecting the appropriate gift.

The user can select the “send email” option, wherein the user drafts an email for transmission by the system. Text messages may also be sent through the system. Email templates may be stored by the system, so that the user can send emails more efficiently. For example, a email template for an upcoming renewal may be prepared by the user so that the user does not have to recreate the email. In some embodiments, the system produces the email and sends it automatically. The user can also select the “greeting card” option. As previously described the user may purchase the greeting card through the vendor network or the user may generate the greeting card through the system. Video and chat features may also be implemented for communications between a user and a contact through the user of Internet Service Protocols (“ISPs”). Phone calls through the Internet may also be made through accessing a contact's information.

The “do nothing now” option allows the user to ignore the notification or select a proper time in the future to be reminded of the event. Accordingly, the user can dismiss the notification or have the notification reappear in one week. The user may control the listing of these notifications. For example, the user may only wish to be notified of a special event one week in advance. Also, the user may select to place notifications for valuable contacts at the top of the list.

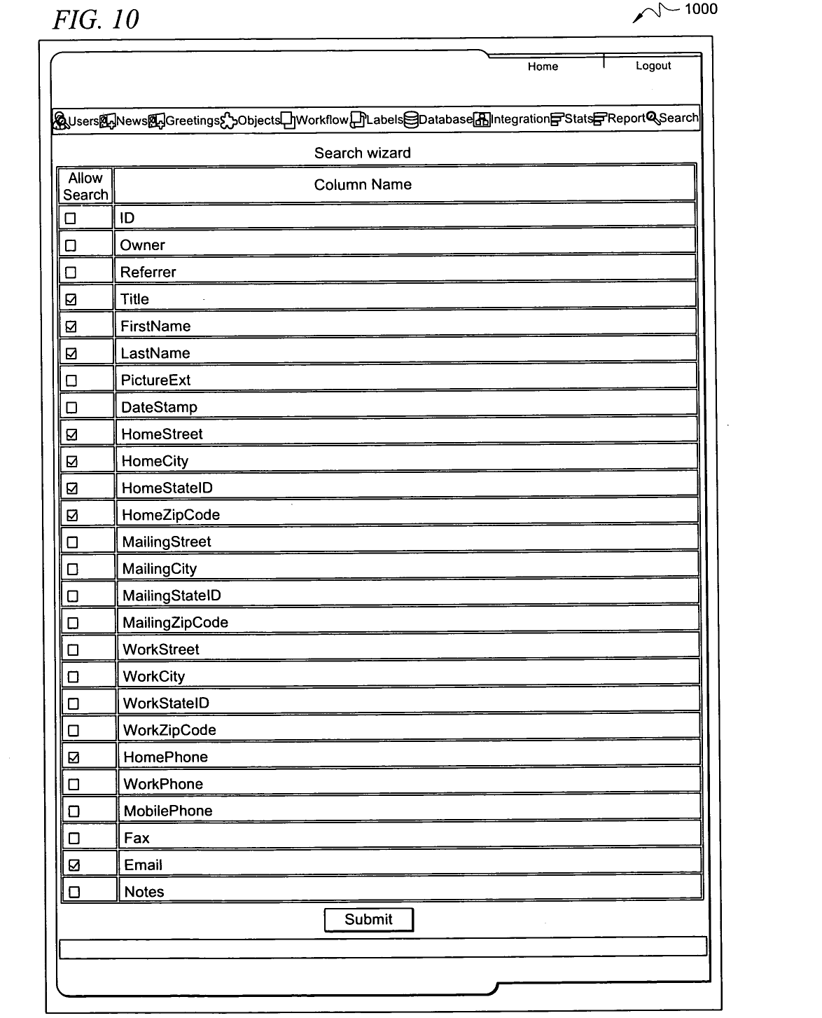

FIG. 10 is a screen shot illustrating search wizard webpage 1000 for a website in one embodiment of the disclosed invention. Search wizard webpage 1000 enables a user to search the website for specific keywords. For example, the user can search all of his contacts that have a phone number with a specific area code or an address within a specific city. The user can also search for contacts that were introduced to him within a specific year or a specific month. As shown in FIG. 10, the user can select many alternative options of search criteria to track and manage his contacts. In one embodiment, the user may also be able to input search criteria to search the vendor network or other areas within the system for specific keywords.

In alternative embodiments, the system may be able to integrate portions of the structured hierarchy of one user with the structured hierarchy of another user. For example, the downline of one contact for a first user may be beneficial to a second user. The first user may allow the second user to export contacts from his structured hierarchy, wherein the contacts are then stored within the second user's structured hierarchy. In this manner, two users may trade contacts to increase the number of contacts each user has within their structured hierarchy.

In alternative embodiments, the system may be able to create maps concerning addresses from the specific contact information. The user may be able to view driving directions from his work address to a contact address through a map produced by the system. Accordingly, the system may automatically produce driving directions from the user's work address to a contact's work address at the request of the user. The user may also be able to view a map of contacts within a certain geographical area. For example, the system may be able to create a map of the user's contacts in a selected city, which allows the user to see the concentration of contacts within specific areas. This feature may enhance the user's ability to find convenient locations for meetings and events.

In alternative embodiments, a section designated for “strategic partners” may be implemented wherein multiple users can create a contact network together. For example, two strategic partners may want to share contacts and enable each partner to access the contacts of the other. The system could send notifications (i.e., by email) that one partner has generated a new contact that may be of value to the other partner. The system may also add a new contact to the other partner's structured hierarchy automatically.

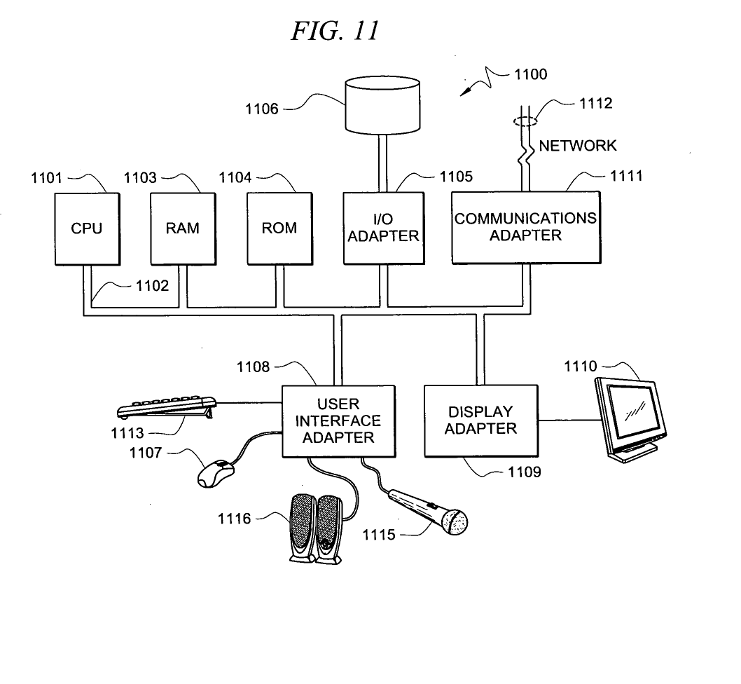

FIG. 11 is a block diagram of a processor-based computer system 1100, configured according to one embodiment of the present invention. That is, computer system 1100 comprises an example system on which embodiments of the present invention may be implemented. Central processing unit (CPU) 1101 is coupled to system bus 1102. CPU 801 may be any general purpose CPU. However, the present invention is not restricted by the architecture of CPU 1101 as long as CPU 1101 supports the inventive operations as described herein. CPU 1101 may execute the various logical instructions according to embodiments of the present invention. For example, CPU 1101 may execute machine-level instructions according to the exemplary operational flows described herein.

Computer system 1100 preferably includes random access memory (RAM) 1103, which may be SRAM, DRAM, SDRAM, or the like. Computer system 1100 preferably also includes read-only memory (ROM) 1104 which may be PROM, EPROM, EEPROM, or the like. RAM 1103 and ROM 1104 hold user and system data and programs, as is well known in the art. Computer system 1100 preferably also includes input/output (I/O) adapter 1105, communications adapter 1111, user interface adapter 1108, and display adapter 1109. I/O adapter 1105, user interface adapter 1108, and/or communications adapter 1111 may, in certain embodiments, enable a user to interact with computer system 1100 in order to input information, such as patient or report data.

I/O adapter 1105 preferably connects to storage device(s) 1106, such as one or more of hard drive, compact disc (CD) drive, floppy disk drive, tape drive, etc. to imaging system 800. The storage devices may be utilized when RAM 1103 is insufficient for the memory requirements associated with storing the necessary data. Communications adapter 1111 is preferably adapted to couple computer system 1100 to a computer network 11 12. User interface adapter 1108 couples user input devices, such as transducer probe 1116, keyboard 1113, pointing device 1107, and microphone 1114 and/or output devices, such as speaker(s) 1115 to computer system 1100. Display adapter 1109 is driven by CPU 1101 to control the display on display device 1110 to, for example, display the imaging presentation prior to its being recorded/saved on the portable media.

It shall be appreciated that the present invention is not limited to the architecture of computer system 1100. For example, any suitable processor-based device may be utilized, including, without limitation, imaging devices, imaging modality units, personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention, including structures incorporated into imaging devices or computer systems.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
receiving information about at least one first contact, wherein the information comprises at least a second contact that introduced the first contact to a user;
storing the received information within a database; and
arranging the contacts within a structured hierarchy, wherein the first contact is displayed as a descendent of the second contact and wherein the structured hierarchy does not represent relationships of the user and the contacts within an organization.

2. The method of claim 1, wherein if the first contact is not introduced to the user by another contact then the first contact is a descendent of the user.

3. The method of claim 1, further comprising calculating an assessment value for at least one contact.

4. The method of claim 3 further comprising calculating said assessment value according to one of:
a valuation of the contacts;
a valuation of transactions; and
a amount of financial business.

5. The method of claim 1, further comprising interfacing a vendor network with the structured hierarchy, wherein the vendor network comprises at least one vendor that provides items and services to the contacts.

6. The method of claim 5, further comprising:
calculating an assessment value for at least one contact; and
utilizing the assessment value of the at least one contact and the vendor network to provide items and services to the contacts, wherein the items and services provided correspond to the assessment value.

7. The method of claim 1, wherein the information received about a first contact further comprises contact specific information comprising at least one event concerning the contact.

8. The method of claim 7, further comprising notifying the user of the at least one event relating to the contact.

9. The method of claim 8, further comprising:
interfacing a vendor network with the structured hierarchy, wherein the vendor network comprises at least one vendor that provides items and services to the contacts; and
utilizing the information received and the vendor network to provide items and services to the contact, wherein the items and services provided correspond to the at least one event relating to the contact.

10. The method of claim 1, further comprising grouping the contacts based upon criteria concerning the information received for the contacts.

11. A computer program product, wherein computer code is disposed on a computer-readable medium, comprising:
computer code for receiving information about at least one first contact, wherein the information comprises at least a second contact that introduced the first contact to a user;
computer code for storing the received information within a database; and
computer code for arranging the contacts within a structured hierarchy, wherein the first contact is displayed as a descendent of the second contact and wherein the structured hierarchy does not represent relationships of the user and the contacts within an organization.

12. The computer program product of claim 11, further comprising computer code for calculating an assessment value for at least one contact.

13. The computer program product of claim 12 further comprising computer code for calculating said assessment value according to one of:
a valuation of the contacts;
a valuation of transactions; and
a amount of financial business.

14. The computer program product of claim 11, further comprising computer code for interfacing a vendor network with the structured hierarchy, wherein the vendor network comprises at least one vendor that provides items and services to the contacts.

15. The computer program product of claim 14, further comprising:
computer code for calculating an assessment value for at least one contact; and
computer code for utilizing the assessment value of the at least one contact and the vendor network to provide items and services to the contacts, wherein the items and services provided correspond to the assessment value.

16. The computer program product of claim 11, wherein the information received about a first contact further comprises contact specific information comprising at least one event concerning the contact.

17. The computer program product of claim 16, further comprising computer code for notifying the user of at least one event relating to the contact.

18. The method of claim 17, further comprising:
computer code for interfacing a vendor network with the structured hierarchy, wherein the vendor network comprises at least one vendor that provides items and services to the contacts; and
computer code for utilizing the information received and the vendor network to provide items and services to the contact, wherein the items and services provided correspond to the at least one event relating to the contact.

19. The computer program product of claim 11, further comprising computer code for grouping the contacts based upon criteria concerning the information received for the contacts.

20. A system comprising:
means for receiving information about at least one first contact, wherein the information comprises at least a second contact that introduced the first contact to a user;
means for storing the received information within a database; and
means for arranging the contacts within a structured hierarchy, wherein the first contact is displayed as a descendent of the second contact and wherein the structured hierarchy does not represent relationships of the user and the contacts within an organization.
